(19) United States
(12) Patent Application Publication
(10) Pub. No.: US 2009/0018698 A1
(43) Pub. Date: Jan. 15, 2009

(54) ROBOT SYSTEM BASED ON NETWORK AND EXECUTION METHOD OF THAT SYSTEM

(75) Inventors: Hyun Kim, Daejeon (KR); Kang-Woo Lee, Daejeon (KR); Joo-Haeng Lee, Daejeon (KR); Tae-Gun Kang, Daejeon (KR); Ae-Kyeung Moon, Daejeon (KR); Young-Ho Suh, Daejeon (KR); Joon-Myun Cho, Daejeon (KR); Young-Jo Cho, Daejeon (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTIT, Daejeon (KR)

(21) Appl. No.: 11/720,397

(22) PCT Filed: Apr. 27, 2005
(86) PCT No.: PCT/KR05/01218

§ 371 Date: Jun. 30, 2008

(30) Foreign Application Priority Data
Nov. 26, 2004 (KR) 10-2004-0098020

(51) Int. Cl. G06F 19/00

(52) U.S. Cl. 700/247; 700/250; 700/253; 901/1; 901/46

(57) ABSTRACT

The present invention relates to a network-based robot system and an executing method thereof. According to an exemplary embodiment of the present invention, predefine environment information is expressed in a universal data model (UDM) described by a linkage that shows a relationship among nodes, each node being an object of a virtual space abstracted by a real physical space. The universal data model is updated based on the context information, event occurrence information is transmitted to a task engine when the context information data value is changed, and the task engine executes a corresponding task through reasoning and invokes an external service. The robot can better recognize the context information by utilizing the external sensing function and external processing function. In addition, the robot system can provide an active service by reasoning the recognized context information and obtaining high-level information.

### BACKGROUND OF THE INVENTION

(a) Field of the Invention

The present invention relates to a network-based robot system and an executing method thereof.

(b) Description of the Related Art

A robot has three functional elements for sensing an external environment, determining a state thereof based on the sensed context information, and executing according to the determined result. At this time, although it is vary important to perceive the context information, conventional robots only perceive the environment by a self-sensor such as an infrared ray sensor and a camera sensor. Accordingly, the robots have a limit in perceiving context information.

Generally, robots have been controlled using a network through the conventional Internet robot technology. The Internet robot technology uses the Internet to remotely control a robot so that a person accessing the Internet determines a state of surroundings based on image information transmitted from the robot and directly orders the robot to perform functions by operating a computer keyboard. Accordingly, the Internet robot technology is included in network-based robot tele-operation technology. However, this technology has a limit in that the robot obtains state information and actively provides service based on the state information.

A paper entitled “New Architecture for Mobile Robots in Home Network Environment using Jini” discloses a communication module technology using Jini for application of external various resources. In this technology, various sensors are used for Jini technology, provided by Sun Micro-Systems. However, extraction of high-level information from low-level sensor information is limited. Accordingly, the robot cannot provide active service based on the perceived state information.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a network-based robot system and an executing method thereof having advantages of more context information recognition by utilizing the external sensing function and external processing function and providing an active service by reasoning the recognized context information and obtaining high-level information. The present invention has further been made in an effort to provide a network-based robot system and an executing method thereof having advantages of providing various and additional services such as controlling home appliances using the robot system. An exemplary network-based robot system according to an embodiment of the present invention includes a environment manager for defining a use environment in a universal data model (UDM) described by a linkage which shows a relationship among nodes, the node being an object of a virtual space abstracted by a real physical space; a sensor interpreter for processing context information based on inputted information and transmitting the processed context information; an event information transmitter for updating a context information data value of the universal data model based on the transmitted context information and transmitting event occurrence information when the context information data is changed; a task manager for executing a corresponding task based on the event occurrence information transmitted from the event information transmitter; and a service invoker for invocating a corresponding service according to the task being executed. An exemplary network-based robot system executing method according to an embodiment of the present invention includes expressing predefined environment information in a universal data model (UDM) described by a linkage that shows a relationship among nodes, the node being an object of a virtual space abstracted by a real physical space; processing context information based on the inputted information; updating the universal data model based on the context information and transmitting event occurrence information to a task engine when the context information data value is changed; and executing a corresponding task by the task engine and invocating a corresponding service according to conditions. In another exemplary network-based robot system executing method for maintaining environment information expressed in a universal data model described by a linkage which shows a relationship among nodes, the node being an object of a virtual space abstracted by a real physical space, the robot system executing method includes processing context information based on the inputted information updating the universal data model based on the context information and transmitting event occurrence information to a task engine when the context information data value is changed, executing a corresponding task by the task engine, and invocating a corresponding service according to conditions.

### BRIEF DESCRIPTION OF THE DRAWINGS

FIG. 1 conceptually shows a system according to an exemplary embodiment of the present invention.

FIG. 2 shows an entire system according to an exemplary embodiment of the present invention.

FIG. 3 shows environmental modeling of a system according to an exemplary embodiment of the present invention.

FIG. 4 and FIG. 5 respectively show a data model for managing context information according to an exemplary embodiment of the present invention.

FIG. 6 shows a process in which necessary tasks are executed from context information according to an exemplary embodiment of the present invention.

### DETAILED DESCRIPTION OF THE EMBODIMENTS

An exemplary embodiment of the present invention will hereinafter be described in detail with reference to the accompanying drawings.

According to an exemplary embodiment of the present invention, a sensing function and a processing function are utilized through a network so that a robot can overcome a context information perceiving limit and a processing limit, and provide various services. In more detail, the robot may use a sensor function incorporated in the external environment rather than increasing a self-sensing function, and it may use a high-function server at a remote place rather than increasing a self-processing function.

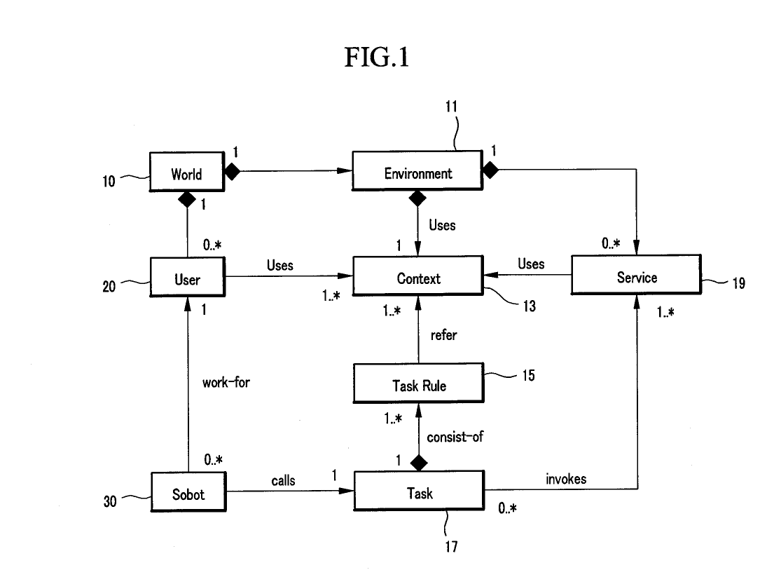

FIG. 1 conceptually shows a system according to an exemplary embodiment of the present invention. According to FIG. 1, the real world includes a physical space and a virtual space. The physical space includes actual physical objects with which a person can interact to perform a task.

References of FIG. 1 are denoted below.
0 . . . *: 0, 1, or more entities are connected.
1 . . . *: 1 or more entities are connected.
0, 1: 0 or 1 entities are connected.
n: exactly n entities are connected.
♦: a constitution relationship (e.g., World, 10) includes an environment 11 and a user 20.

Arrow: a relationship of a subject, a verb, and a modifier.

The constituents of FIG. 1 and the relationship thereof will be described with respect to the references.

The world 10 is a virtual space abstracted from the physical space, and is expressed by several environments 11 that are mapped from physical objects.

An environment is abstracted from a predetermined defined space (place), and it can communicate with a computer and includes various sensors and devices having unique identifiers.

The service 19 is a program module of which the sensors or devices can execute the physical functions in the virtual space.

The user 20 can access the virtual space through the sobot 30 because the real world user is mapped with a virtual space user having identifier, profile, and preference information.

The sobot is similar to an avatar, and acts as a robot of the physical space so that it accepts the world state, executes a task according to the world state, and changes the world state.

For example, the user can make the robot system provide a home service through the sobot from the outside, such as from a company. In more detail, the sobot avatar appears in a portable terminal such as a PDA, and the sobot accepts a user input and transmits the same to a robot in a house. In addition, the robot system transmits a message to the PDA and the user perceives the message through the sobot avatar of the PDA.

In more detail, when the robot system senses a gas leakage in a user's house and a gas leakage message is transmitted to the sobot, the user can confirm the corresponding context information through the sobot avatar appeared in the PDA terminal. In addition, when the user commands the sobot to switch off a gas valve, the sobot transmits this command to the robot system in a house so that the robot system executes the corresponding service that is appropriate for the context information. The above process is realized by executing the task described below.

The task 17 is a set of serial actions which must be executed according to a user's request or necessary context information that can each constitute an executing unit. The task is described in a task rule 15. The robot system operates by invocating a service according to the task rule.

The task rule 15 describes service execution rules of the individual tasks, and is formed in consideration of a context information 13 such as a user's command and an environment change.

The context information 13 is basically based on reasoning rules with which new information can be acquired by combining specific environmental data and relationships thereof.

For example, when the temperature is varied at a specific place, the task rule that commands to turn on the air conditioner in the corresponding place may be described as below.

on ( $place.temporature::ValueChanged e )
when exists( e.value > $place.resident.preferred_temp.high ) {

$place.air_conditioner.turnOn( );

}

At this time, the context information includes a user's preference temperature (resident.preferred_temp.high) and a place temperature (place.temperature).

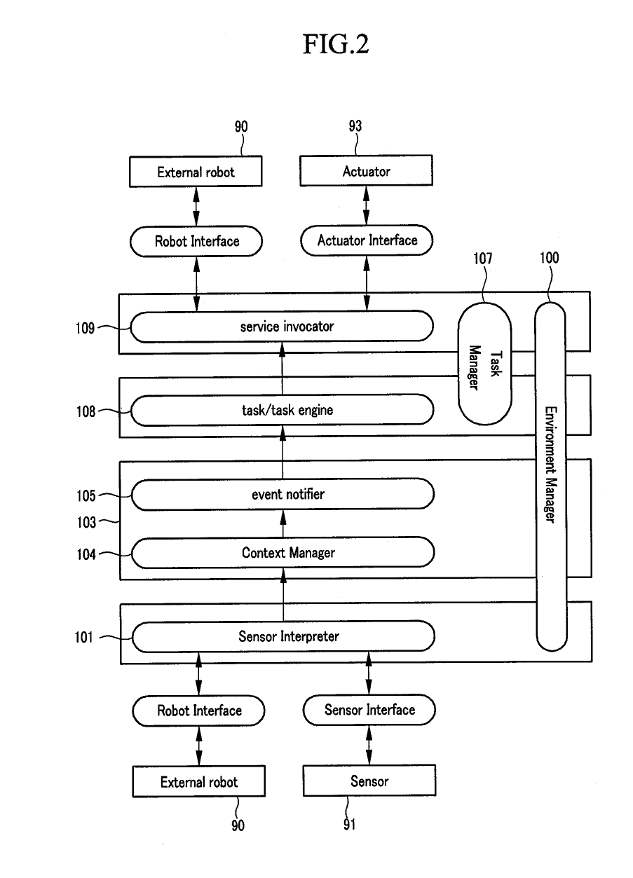

The robot system according to an exemplary embodiment of the present invention will now be described with reference to FIG. 2.

The robot system according to an exemplary embodiment of the present invention includes an environment manager 100, a sensor interpreter 101, an event information transmitter 103, a task manager 107, a task engine 108, and a service invoker 109. For example, the robot system can be realized as a type of computer server that can receive sensing information from the exterior and invoke a necessary service through a series of information processing.

The task engine 108 may be included in the task manager 107, and the environment manager 100 may include the service invoker 109.

The environment manager 100 writes information in advance such that the robot recognizes the context information. The information to be prepared in advance includes the sensor output information that informs of the environment context information, and information of the device that executes a task according to the context information.

The sensor and the device may be defined as a service. Therefore, the environment manager can previously produce information through service modeling, environment modeling, etc. A more specific description thereof will be given below.

The sensor interpreter 101 is a module that processes input information such as sensing information transmitted from an appliance system, for example a physical sensor 91 or a general external robot 90 that may transmit environment sensing information, or a user command, and transmits this processed information to a context information manager 104 described below.

The event information transmitter 103 updates the context information data value of a universal data model (UDM) based on the context information transmitted from the sensor interpreter, and transmits event occurrence information to the robot system when the context information data value is changed.

The event information transmitter 103 may include the context information manager 104 and an event notifier 105.

The context information manager 104 manages the context information processed by the sensor interpreter 101.

The method for processing the information includes combining the input information and changing an expressing form to be appropriate for the high-level appliance of the system. The context information manager 104 outputs the context information transmitted from the sensor interpreter 101 to the UDM, and manages the same at a memory.

When the context information is changed, the context information manager 104 transmits the event to the event notifier 105, and provides the context information to the task engine 108 such that the task engine executes a task. The UDM and UDM management will now be described in detail.

The event notifier 105 transmits the event transmitted from the context information manager 104 through the sensor or other external services to the task manager 107 so that the corresponding task is executed.

The task manager 107 starts the individual tasks, and manages the task running process. In addition, the task engine 108 executes a real task according to the context information.

More specifically, the task manager 107 is linked with the external context information and loads the corresponding task to the task engine 108 so that the task engine 108 starts the corresponding task.

For example, when there are tasks such as a conference helper or TV helper and a voice command context information such as “Turn on TV” is recognized, the task manager 107 loads the TV helper task to the task engine 108 so that it can be executed. At this time, the task engine 108 executes the TV helper task that is appropriate for the context information transmitted using a reasoning engine.

The service invoker 109 is a module for invocating a service that is appropriate for the context information, and the service invoker 109 is operated such that an external robot 90, an external device, an external actuator 93, etc., that is capable of communicating with the robot system receives the service invocating information and executes the corresponding service.

For example, when there is a temperature sensor and an air conditioner in a room in which there is a robot system, the air conditioner and the temperature sensor information are previously defined by the environment manager 100 and are expressed in the UDM by the robot system.

When the temperature value is transmitted from the sensor interpreter 101 to the context information manager 104, the context information manager 104 changes the temperature value in the room context information expressed in the UDM and notifies the event notifier 105 of the temperature value changing event.

The event notifier 105 records the tasks corresponding to the specific temperature value changing event, and the task manager 107 loads the corresponding task such as an air conditioner controlling task to the task engine 108 according to the information transmitted from the event notifier 105 so that the air conditioner controlling task is executed.

At this time, the environment manager 100 provides the environment information previously defined, i.e. the service information, to the task engine 108, and the task engine 108 executes a task based on the service information transmitted from the environment manager 100 and the service invoker 109 is operated so that the air conditioner service is invoked.

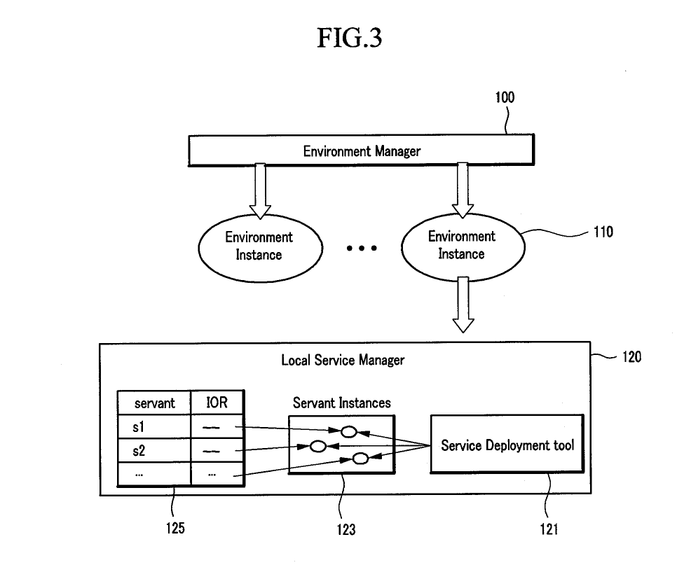

The information to be previously prepared by the environment manager 100 such that the robot recognizes the context information according to an exemplary embodiment of the present invention is described in detail with reference to FIG. 3.

The environment manager 100 writes the environment information through environment modeling and saves the same.

The environment modeling includes the defined domain of the physical space and the available resources of the corresponding domain. The available resources include a sensor or an apparatus that is capable of communicating through a network, and the sensor or the apparatus cooperates with the robot system and is provided in a form of a service operated on the network.

The environment information includes the places, the geometric relationship of the places, the available devices and services of each place, etc. Therefore, the environment manager 100 includes a place modeler, a device modeler, and a service modeler, and it executes the environment modeling.

The place modeler defines spatial position relationships and devices and services which constitute each place. The place is made up of sites, and a site is an area such as a bedroom and a kitchen in an apartment, a classroom and a teacher's room in a school, or an office and a conference room in a company. A single place includes several devices and services, and each single place may include several places.

The device modeler stipulates the task that each device can perform, and defines interfaces that are capable of invocating respective functions for achieving each task. The device may correspond to home appliances that provide various informations, for example a TV set and an air conditioner of a living room, a refrigerator and a gas range of a kitchen, and a printer and a notebook computer of an office, which the software robot system can control. Also, the device may include various sensing devices such as a position sensor and a temperature sensor.

The service modeler stipulates each service requirement and defines an interface that can invoke a function for performing each service requirement. The services include a device management service, a schedule management service, a music service, etc., and a unit task may be executed or assisted by combining various devices and application programs of the specific place.

When the place modeler, the device modeler, the service modeler, etc., finish the environment modeling, codes recorded by the service modeler are executed so that a service is prepared.

The environment manager 100 manages each environment configuration and information so as to perform the environment modeling, and realizes an accessible path to the environment through an environment instance 110.

The specific place environment may be defined as a set of services that the user can use at the specific place. Each environment boundary may be defined such that each is coincident with a real physical domain. However, it may not be limited thereto. For example, each building floor may become an environment. Also, on the same floor a conference room and a laboratory, for example, may become an environment.

According to such characteristics, the environment may be hierarchically modeled. When an apartment complex having several buildings is modeled, the apartment complex may become the highest-level environment and each building may become a lower-level environment, such as complex/1st building, complex/2nd building, etc. In addition, each floor may be hierarchically modeled for every building, such as complex/1st building/1st floor, complex/1st building/2nd floor, etc., and each apartment may be hierarchically modeled for each floor, such as complex/1st building/1st floor/No. 101 and complex/1st building/1st floor/No. 102.

The environment manager 100 manages each hierarchical environment structure and information in the above-described manner.

Each environment instance 110 conceptually includes one local service manager 120.

The local service manager 120 includes a module for managing the services that each environment can use. For example, in ETRI/7th Building/L89, the local service manager 120 manages the services to be executed in L89. When L89 has a controllable temperature sensor and air conditioner, the local service manager 120 can manage the temperature sensor and air conditioner service.

The local service manager 120 may include a service deployment tool 121, a service management module 123, and a naming service module 125. The service deployment tool 121 may download a desired service from a service-realizing recording system and install the same. The service management module 123 manages the length of time each service is provided, and the naming service module 125 manages interoperable object references (IOR) of each service instance. For example, when the present system is developed using CORBA, an IOR management module of SERVANT is desired to execute each service.

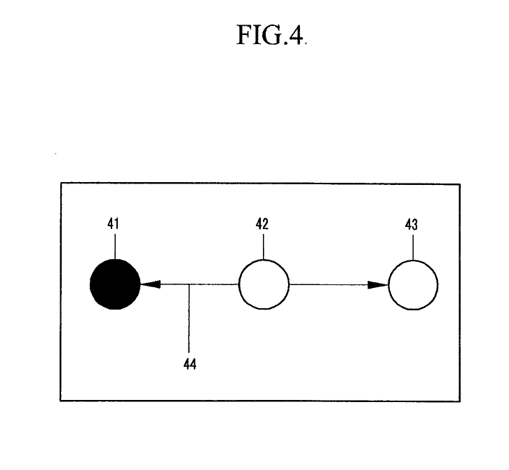

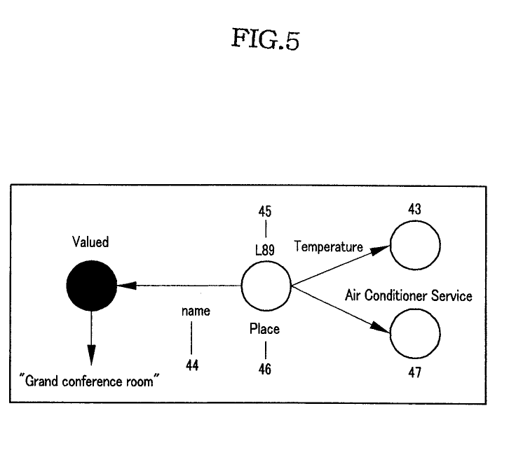

The UDM for expressing various context informations and the context information management will be described in detail with reference to FIG. 4 and FIG. 5.

In this embodiment, all context information may be expressed in the UDM. The basic UDM data structure is shown in FIG. 4.

In the UDM, all context information is expressed in a linkage 44 among nodes 41, 42, and 43. The nodes express objects in the virtual space and include a person, a place, a task, a service, etc. In addition, all nodes 41, 42, and 43 may respectively have a unique identifier 45 (see FIG. 5) and a type 46 (see FIG. 5), and a specific type-node, i.e., “Valued” node 41, indicates a node having a specific value.

The linkage 44 describes the relationship among the nodes, and is expressed by a directivity arrow and has a name for expressing a meaning thereof. The node at which the arrow starts may be called “from node 42” and the node at which the arrow ends may be called “to node 43”.

A grand conference room is expressed in the UDM as shown in FIG. 5.

“L89” is the specific place identifier 45. Accordingly, “L89” may be expressed in a PLACE node 46 and may have a name, e.g., “grand conference room” 44. When ETRI/7th Building/L89 has a temperature sensor 43 and an air conditioner and an air conditioner control service 47 can be provided, it may be expressed in the UDM as shown in FIG. 5.

When the conference room L89 has a higher temperature than a specified temperature, the temperature node value is changed so that the temperature changing event occurs and the air conditioner may be turned on.

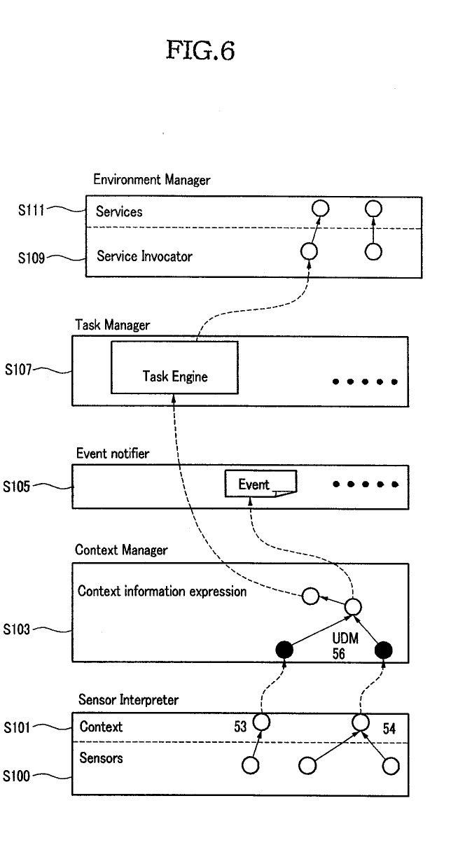

A method for realizing the robot system according to an exemplary embodiment of the present invention will be described in detail with reference to FIG. 6.

First, the modeling for the specific place and the service may be performed such that the robot system recognizes the context information.

For example, in order to use the air conditioner service in the L89 conference room according to the context information, environment modeling of the L89 sensors and resources and service modeling for connecting a desirable service are required. When ETRI/7th Building/L89 has a temperature sensor and a humidity sensor, the sensor interpreter 101 combines the two sets of sensor information and then processes temperature-humidity index information. The processed temperature-humidity index information may be defined from the given environment modeling, and the defined information may be expressed in the UDM format.

That is, the UDM obtained by modeling L89 may have the temperature-humidity index node, and the context information manager 104 may change the corresponding node value with the temperature-humidity index value transmitted from the sensor interpreter 101. When the value is changed, the event notifier 105 transmits the corresponding contents to the service so that the service is actively executed.

When the previous information is prepared as described above, the context information is acquired through the sensor from the exterior (S100).

Next, the sensor interpreter 101 processes input information such as that from a physical sensor, an application system, a user command, etc., to be appropriate for the context information, and transmits the processed information to the context information manager 104 (S100). As described above, the sensor interpreter acquires a temperature value and a humidity value from sensors and combines these values, thereby evaluating a temperature-humidity index value 54, or changes the same into a necessary expressing format 53 by applying the individually expressed data.

The context information manager 104 manages the context information transmitted from the sensor interpreter 101 in the separate memory (S103). The context information is managed while being expressed in the UDM format 56 in the memory. The context information manager 104 transmits the event to the event notifier 105 when the context information is changed, and also provides the necessary context information to the task engine 108.

For example, the context information manager 104 can manage the context information by changing the UDM temperature node value when the temperature value is inputted from the sensor interpreter 101.

The event notifier 105 transmits the event to the corresponding task, wherein the event is transmitted from the context information manager 104 through the sensor or other external services. As described above, the changed temperature information is transmitted for the specific task such as the air conditioner service (S105).

Next, the task is executed according to the transmitted event (S107). The task manager 107 loads the individual tasks to the task engine 108 and starts the task, and it also manages a task running process. In addition, the task engine 108 executes an actual task according to the task through the context information regarding the corresponding task and the reasoning engine that is capable of implementing the task rule. In addition, the service appropriate for the context information is invoked and executed (S109, S111).

For example, in the case that there is a task rule for running the air conditioner when the temperature is above 25° C., when the temperature information transmitted by the event is 26° C. and it is determined that the air conditioner operating condition is satisfied through the reasoning engine, the air conditioner operating service will be invoked. Therefore, the air conditioner can be operated in the specific place.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For example, the robot system according to the exemplary embodiment of the present invention may be realized in an integrated or differentiated server format, depending on the functions. Also, the task engine 108, the service invoker 109, the place modeler, the device modeler, and the service modeler, etc., may not be respectively included in the task manager 107 or the environment manager 100 but may constitute a separate module.

According to an exemplary embodiment of the present invention, the robot can better recognize the context information by utilizing the external sensing function and external processing function. Also, the robot system can provide an active service by reasoning the recognized context information and obtaining high-level information.

Also, since the robot system can cooperate with the given services through environment modeling, various services can be provided and additional services such as controlling home appliances using the robot system can be provided.

In addition, when the context information includes a user's profile information and preference information, etc., the robot service can be provided according to the user's characteristics.

1. A network-based robot system executing method, comprising:
a) expressing a predefined environment information in a universal data model (UDM) described by a linkage which shows a relationship among nodes, a node being an object of a virtual space abstracted by a real physical space;
b) processing context information based on the inputted information;
c) updating the universal data model based on the context information and transmitting event occurrence information to a task engine when a context information data value is changed; and
d) executing a corresponding task by the task engine and invocating a corresponding service according to conditions.

2. The network-based robot system executing method of claim 1, wherein the nodes include at least one selected from a group of a place, a person, a task, and a service.

3. The network-based robot system executing method of claim 1, wherein the linkage includes directivity information and meaning information.

4. The network-based robot system executing method of claim 1, wherein the user environment information includes at least one selected from a group of a geometrical relationship of places, an available device of each place, and an available service of each place.

5. The network-based robot system executing method of claim 4, wherein the places includes a task executing place and at least one device and service, and the place becomes a user moving unit.

6. The network-based robot system executing method of claim 1, wherein at step b), it includes processing input information into the context information using at least one scheme of first and second schemes, the first scheme combining at least two sets of input information into a single context information and the second scheme changing an expression of the input information into context information.

7. The network-based robot system executing method of claim 1, wherein the event occurrence information includes task information corresponding to the respective events.

8. The network-based robot system executing method of claim 7, wherein the step d) includes d-1) reasoning a task based on the task rule for describing the context information for the corresponding task and the service execution of the corresponding task; and
d-2) invocating the corresponding service when the context information satisfies the task rule.

9. The network-based robot system executing method of claim 1, wherein the service is a program module for executing a physical function of an inner-environment sensor or device in the virtual space.

10. A network-based robot system executing system, comprising:
a environment manager for defining a using environment in a universal data model (UDM) described by a linkage which shows a relationship among nodes, the node being an object of a virtual space abstracted by a real physical space;
a sensor interpreter for processing context information based on the inputted information and transmitting the processed context information;
an event information transmitter for updating a context information data value of the universal data model based on the transmitted context information, and transmitting event occurrence information when the context information data is changed;
a task manager for executing a corresponding task based on the event occurrence information transmitted from the event information transmitter; and
a service invoker for invocating a corresponding service according to the executing task.

11. The network-based robot system executing system of claim 10, wherein the nodes include at least one selected from a group of a place, a person, a task, and a service, and the linkage includes directivity information and meaning information.

12. The network-based robot system executing system of claim 10, wherein the sensor interpreter processes input information into the context information using at least one scheme of first and second schemes, the first scheme combining at least two input information into a single context information and the second scheme changing an expression of the input information into context information.

13. The network-based robot system executing system of claim 10, wherein the event information transmitter include a context information manager for updating the context information data value of a universal data model (UDM) based on the context information transmitted from the sensor interpreter and transmitting event occurrence information to the robot system when the context information data value is changed; and an event notifier for including task information corresponding to the respective occurrence events and transmitting the task information to the task manager for transmitting the event generation information.

14. The network-based robot system executing system of claim 13, wherein the task manager includes a task engine for executing the corresponding task transmitted from the event notifier.

15. The network-based robot system executing system of claim 13, wherein the task engine includes a reasoning engine for reasoning the task based on the task rule for describing the context information for the corresponding task and the service execution of the corresponding task, and invocating the corresponding service when the task rule is satisfied.

16. The network-based robot system executing system of claim 10, wherein the using environment includes at least one selected from a group of a geometrical relationship of the places, an available device of each place, and an available service of each place.

17. The network-based robot system executing system of claim 10, wherein the environment manager includes a place modeler defining a spatial position relationship and devices and services which constitute each place; a device modeler for describing what each device can perform, and defining interfaces capable of invocating respective functions for achieving each performance; and a service modeler for describing each service requirement and defining an interface that can invoke a function for performing each service requirement.

18. The network-based robot system executing system of claim 10, wherein the environment manager includes a local service manager for managing each set of environment configuration information, realizing a path that is accessible to the environment through the producing of an environment instance, and managing the service that each environment can use for each environment instance.

19. The network-based robot system executing system of claim 18, wherein the local service manager includes a service deployment tool for installing a desirable service; a service management module for managing the length of time each service is provided, and a naming service module for managing interoperable object references (IOR) of each service instance.

20. The network-based robot system executing system of claim 10, wherein the service is a program module for executing a physical function of an inner-environment sensor or device in the virtual space.

21. A network-based robot system executing method for maintaining environment information expressed in a universal data model (UDM) described by a linkage which shows a relationship among nodes, each node being an object of a virtual space abstracted by a real physical space, the robot system executing method comprising:
a) processing context information based on the inputted information;
b) updating the universal data model based on the context information and transmitting event occurrence information to a task engine when the context information data value is changed; and
c) executing a corresponding task by the task engine and invocating a corresponding service according to conditions.

22. The network-based robot system executing system of claim 16, wherein the environment manager includes a place modeler defining a spatial position relationship and devices and services which constitute each place; a device modeler for describing what each device can perform, and defining interfaces capable of invocating respective functions for achieving each performance; and a service modeler for describing each service requirement and defining an interface that can invoke a function for performing each service requirement.

23. The network-based robot system executing system of claim 16, wherein the environment manager includes a local service manager for managing each set of environment configuration information, realizing a path that is accessible to the environment through the producing of an environment instance, and managing the service that each environment can use for each environment instance.

24. The network-based robot system executing system of claim 23, wherein the local service manager includes a service deployment tool for installing a desirable service; a service management module for managing the length of time each service is provided, and a naming service module for managing interoperable object references (IOR) of each service instance.
